(19) United States
(12) Patent Application Publication
(10) Pub. No.: US 2026/0077706 A1
(43) Pub. Date: Mar. 19, 2026

(54) TRAILER CLEARANCE LIGHT WIRING SYSTEM INCLUDING WIRING HARNESSES

(71) Applicant: Michael B. Rosteski, Swan River (CA)

(72) Inventor: Michael B. Rosteski, Swan River (CA)

(21) Appl. No.: 19/325,753

(22) Filed: Sep. 11, 2025

Related U.S. Application Data
(60) Provisional application No. 63/695,581, filed on Sep. 17, 2024.

(51) Int. Cl. B60Q 1/30; B60R 16/02; B60R 16/023

(52) U.S. Cl. CPC B60Q 1/305; B60R 16/0215; B60R 16/0239

(57) ABSTRACT

A clearance light with a socket connector formed thereon is connected with a junction box on a trailer using a wiring harness including a splitter within sealed envelope and integral pigtails assemblies for quick connection to the clearance lights, which in turn allows quick installation of wiring for the clearance lights on the trailer. The splitter has a first terminal and a second terminal mounted internally within the sealed envelope fully enclosing the first terminal and the second terminal within the sealed envelope. First and second input leads in conductive communication with the first and second terminals of the splitter extend externally of the sealed envelope for connection to power and ground terminals of the junction box. A pigtail assembly includes a plug for connection to the socket connector of the clearance light and a pair of pigtail leads connected to the first and second terminals of the splitter.

This application claims the benefit under 35 U.S. C.119(e) of U.S. provisional application Serial No.63/695,581, filed September 17,2024.

### FIELD OF THE INVENTION

The present invention relates to a wiring system for wiring clearance lights to a junction box on a trailer, and more particularly, the present invention relates to a system include various wiring harnesses arranged to cooperate with one another in wiring trailer clearance lights.

### BACKGROUND

A typical transport trailer for transporting cargo on a highway includes a plurality of clearance lights one each side and end of the trailer, typically in proximity to the corners of the trailer to provide an indication of the boundaries of the trailer when operating the trailer at night. All of the clearance lights are typically wired to a main junction box providing electrical power to the clearance lights; however, the wiring tends to become corroded over time from precipitation and road salts and the like. Replacing the wiring for clearance lights typically requires individually splicing the wiring for each light into a main set of leads extending along a length of the trailer, which is time consuming, and if not done carefully with skill, can result is subsequent penetration of moisture and corrosive agents into the new wiring once complete.

### SUMMARY OF THE INVENTION

According to one aspect of the invention there is provided a method of connecting a clearance light with a junction box on a trailer in which the clearance light includes a socket connector formed thereon and the junction box includes a power terminal and a ground terminal therein, the method comprising:
providing a wiring harness comprising (i) a splitter having a first terminal and a second terminal mounted internally within a sealed envelope fully enclosing the first terminal and the second terminal within the sealed envelope, (ii) a first input lead and a second input lead in conductive communication with the first and second terminals of the splitter respectively in which the first input lead and the second input lead extend from the splitter externally of the sealed envelope; and (iii) a pigtail assembly including a plug and a pair of pigtail leads in conductive communication between the plug and the first and second terminals of the splitter respectively;
connecting the first input lead and the second input lead of the wiring harness to the power terminal and the ground terminal of the junction box; and connecting the plug of the pigtail assembly to the socket connector of the clearance light.

Use of wiring assemblies including a splitter within sealed envelope and integral pigtails assemblies for quick connection to the clearance lights, allows quick installation of wiring for the clearance lights, while also resulting in a secure connection once complete that provides superior resistance to penetration of moisture and corrosion into the replacement wiring.

According to a second aspect of the present invention there is provided a wiring harness for a trailer including clearance lights with socket connectors formed thereon and a junction box having a power terminal and a ground terminal therein, the wiring harness comprising:
a splitter having a first terminal and a second terminal mounted internally within a sealed envelope fully enclosing the first terminal and the second terminal within the sealed envelope;
a first input lead and a second input lead in conductive communication with the first and second terminals of the splitter respectively in which the first input lead and the second input lead extend from the splitter externally of the sealed envelope so as to be arranged for respective conductive communication with the power terminal and the ground terminal of the junction box;
at least one pigtail assembly including (i) a plug arranged for mating connection with the socket connector of a respective one of the clearance lights and (ii) a pair of pigtail leads in conductive communication between the plug and the first and second terminals of the splitter respectively in which the pigtail leads extend from the splitter for connection with the plug externally of the sealed envelope; and
a first output lead and a second output lead in conductive communication with the first and second terminals of the splitter respectively in which the first output lead and the second output lead extend from the splitter externally of the sealed envelope so as to be arranged for respective conductive communication with a first input lead and a second input lead of another wiring harness.

According to a further aspect of the present invention there is provided a wiring harness for a trailer including clearance lights with socket connectors formed thereon and a junction box having a power terminal and a ground terminal therein, the wiring harness comprising:
a splitter having a first terminal and a second terminal mounted internally within a sealed envelope;
a first input lead and a second input lead in conductive communication with the first and second terminals of the splitter respectively in which the first input lead and the second input lead extend from the splitter externally of the sealed envelope so as to be arranged for respective conductive communication with the power terminal and the ground terminal of the junction box; and
two pigtail assemblies, each including (i) a plug arranged for mating connection with the socket connector of a respective one of the clearance lights and (ii) a pair of pigtail leads in conductive communication between the plug and the first and second terminals of the splitter respectively in which the pigtail leads extend from the splitter for connection with the plug externally of the sealed envelope.

The at least one pigtail assembly may comprise two pigtail assemblies, each including (i) a plug arranged for mating connection with the socket connector of a respective one of the clearance lights and (ii) a pair of pigtail leads in conductive communication between the plug and the first and second terminals of the splitter respectively.

The first input lead and the second input lead may each include a wire connector mounted on a distal end of the input lead, in which the wire connector is arranged for connecting the input lead to a corresponding wire coupled to one of the terminals of the junction box such that the corresponding wire and the input lead are joined end to end with one another.

The input leads may have a length corresponding to a distance between a corner of the trailer and the junction box of the trailer, or a length which is greater than a length of the trailer.

The leads may be connected to one another at each terminal of the splitter by crimping, by soldering, or by a combination of crimping and soldering.

The sealed envelope of the splitter may be formed of plastic material which undergoes shrinkage upon application of heat.

### BRIEF DESCRIPTION OF THE DRAWINGS

One embodiment of the invention will now be described in conjunction with the accompanying drawings in which:

FIG. 1 is a perspective view of a first wiring harness according to the trailer clearance light wiring system of the present invention;

FIG. 2 is a schematic representation of internal wiring of the first wiring harness of the according to FIG. 1;

FIG. 3 is a schematic representation of internal wiring of a second wiring harness trailer clearance light wiring system of the present invention;

FIG. 4 is a schematic representation of internal wiring of a third wiring harness trailer clearance light wiring system of the present invention; and

FIG. 5 is a schematic representation of a trailer upon which the trailer clearance light wiring system of the present invention is installed, indicating placement of the first, second and third wiring harnesses of the system thereon.

In the drawings like characters of reference indicate corresponding parts in the different figures.

### DETAILED DESCRIPTION

Referring to the accompanying figures there is illustrated a trailer clearance light wiring system generally indicated by reference numeral 10. The system 10 is particularly suited for use with a trailer 12 including clearance lights 14 supported at various locations thereon for supplying electrical power to the clearance lights.

In the illustrated embodiment, the trailer 12 comprise a cargo deck or box 16 extending longitudinally between a front end 18 and a rear end 20 of the trailer for transporting cargo thereon along a highway and the like. The front end 18 of the trailer includes a kingpin 22 for towing connection to a highway tractor (not shown). The rear end 20 of the trailer includes wheels 24 supporting the trailer thereon for rolling movement along the ground in a forward longitudinal direction together with the highway tractor.

The trailer 12 further includes a junction box 26 supported at the front end of the trailer according to the illustrated example. The junction box 26 forms an electrical connection to the highway tractor to receive electrical power from the tractor and redistributes the electrical power to various components of the trailer 12, including the clearance lights 14. The junction box 26 includes a positive terminal 28 connected to a positive electrical power source of the tractor, and a ground terminal 30 connected to an electrical ground of the tractor. The positive terminal 28 and the ground terminal 30 are mounted internally within a housing of the junction box 26.

According to the illustrated example, the clearance light 14 includes a rear housing 32 formed of durable plastic material having a rear face 34 at the rear side of the exterior of the light assembly. A socket connector 36 is formed in the rear face which defines two connector pins therein that form a mating connection with a typical plug 64 of a pigtail connector as described in further detail below. A light source (not shown), for example a light emitting diode or a bulb, is mounted on a front face of the rear housing 32 in electrical communication with the connector pins of the socket connector 36. The two connector pins of the socket connector 36 are intended for electrical communication with the positive and ground terminals of the junction box to deliver electrical power to the light source and illuminate the light source. A lens 38 formed of a translucent plastic material is mounted to span the front face of the rear housing 32 to cover the light source and diffuse the light emitted by the light source.

The wiring system 10 according to the present invention includes a first wiring harness 40A, a second wiring harness 40B, and a third wiring harness 40C installed at respective locations on the trailer 12 as described in further detail below. The common features of the various wiring harnesses will first be described.

In each instance the wiring harness 40A, 40B or 40C includes a splitter 42 defining a junction of a plurality of leads. The leads generally include a first set of leads joined to one another internally within the splitter to define a first terminal 44 corresponding to the positive terminal of the junction box 26, and a second set of leads joined to one another internally within the splitter to define a second terminal 46 corresponding to the ground terminal of the junction box 26. The splitter also includes an envelope 48 formed of a tube or jacket of plastic material fully surrounding the first terminal 44 and the second terminal 46 to form a fully sealed envelope about the terminals. The plastic material is arranged to shrink in size upon the application of heat to form a sealed connection about the leads extending externally of the splitter envelope from ends of the leads connected internally to the terminals of the splitter respectively. Each lead extends externally of the envelope through a respective opening in the envelope which is sealed about the lead to prevent penetration of moisture and debris into the interior of the splitter where the terminals are located.

Each wiring harness also includes a first input lead 50 and a second input lead 52 which are connected to the first terminal 44 and the second terminal 46 respectively at the proximal ends of the leads located internally within the envelope 48. Each of the input leads 50 and 52 extends through respective openings in the envelope that are sealed about the leads so that the leads can extend externally of the envelope to opposing distal ends 54 which are connected to respective terminals 28 and 30 of the junction box directly or indirectly. In some instances, the input leads protrude from the envelope by a short distance of less than 10 inches, for example in the range of 1 to 5 inches so as to be suited for connection to existing wiring of a trailer. In other instances, the input leads have a suitable length to extend from the junction box to one of the nearest corners of the trailer so as to be several feet in length or more. In yet a further embodiment, the input leads may have a length which is greater than the length of the trailer in the longitudinal direction so that the input leads can span from the junction box to one of the distal corners of the trailer.

Each input lead 50 or 52, like all other leads described herein, is an elongated conductive wire having an electrically insulated plastic sheath surrounding the wire along the length thereof. An end portion at each distal end 54 can be stripped of the sheath for connection to wiring extending from the junction box using a suitable wire connector 56 that is integral with the end of the input lead or may be added on by a user of the harness. The wire connector 56 may be a conventional connector for connecting to leads end to end in series with one another. In this instance the wire connector 56 includes an inner tube of a crimpable conductive material defining a pair of sockets 58 at longitudinally opposed ends of the connector. A surrounding jacket 60 of electrically insulating material fully surrounds the inner tube defining the sockets 58. The stripped end portion of a corresponding input lead can then be inserted into the socket 58 at one end of the connector, followed by application of an external clamping force to crimp and mechanically retain the stripped end of the input lead within the socket. The existing lead extending from the junction box can be similarly stripped at the end portion thereof and inserted into the other socket 58 of the wire connector for crimping and conductively joining the input lead to the existing lead.

Each wiring harness 40A, 40B or 40C, also includes one or more pigtail assemblies 62. Each pigtail assembly includes a plug 64 including a pair of connector pins formed thereon which form a conductive connection with corresponding ones of the connector pins of a socket connector 36 of a corresponding clearance light 14 when the plug 64 is mated with the socket connector. The plug 64 may be connected to the socket in a readily releasable manner, for example by friction fit or use of a spring clip having a releasable catch that retains the plug within the socket until the catch is released.

Each pigtail assembly 62 also includes a pair of pigtail leads 66 in conductive communication with respective first and second terminals 44 and 46 of the splitter 42 at proximal ends of the pigtail leads. The pigtail leads extend through respective openings in the envelope which are sealed about the leads so that the distal ends of the pigtail leads 66 are connected to the plug 64 in conductive communication with the connector pins respectively. The pigtail leads 66 may have a length in the range of 5 to 20 inches for example, but are shorter in length so as to be less than 1 foot in length for example.

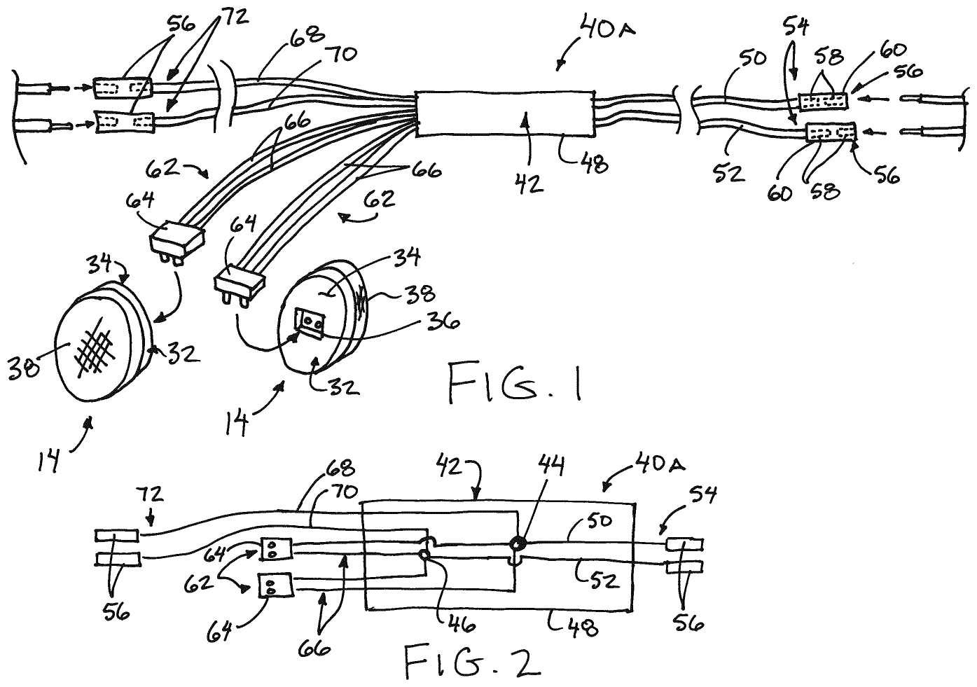

Turning now to the first wiring harness 40A according to FIGS. 1 and 2, and the second wiring harness 40B, in these instances the wiring harness further includes a first output lead 68 and a second output lead 70 which are connected to the first terminal 44 and the second terminal 46 respectively at the proximal ends of the leads located internally within the envelope 48. Each of the output leads 68 and 70 extend through respective openings in the envelope that are sealed about the leads so that the leads can extend externally of the envelope to opposing distal ends 72. The output leads in the illustrated embodiment preferably protrude from the envelope by a short distance of less than 10 inches, for example in the range of 1 to 5 inches; however, in other instances the output leads may extend much greater lengths, such as being greater in length than the trailer to provide replacement wiring extending between clearance lights at longitudinally opposing corners of the trailer.

Each of the output leads 68 and 70 is arranged at the distal ends 72 thereof similarly to the distal ends 54 of the input leads so as to be arranged for connection to wire connectors 56 for connection to other wiring. The first and second wiring harnesses 40A and 40B are typically installed at an intermediate location between the junction box and other clearance lights of the trailer such that the output leads are arranged for conductive communication with the first and second input leads of another downstream wiring harness.

Turning now to the first wiring harness 40A shown in FIGS. 1 and 2, the harness in this instance includes the splitter 42, the first and second input leads 50 and 52, the first and second output leads 68 and 70, and two pigtail assemblies 62. The first wiring harness 40A is particularly suited for installation at a corner of the trailer nearest to the junction box such that the pigtail assemblies can be connected to the clearance lights 14 on two adjacent walls of the trailer that are perpendicular to one another at the corner of the trailer, for example a clearance light at the side of the trailer and a clearance light at the end of the trailer adjacent to the corner.

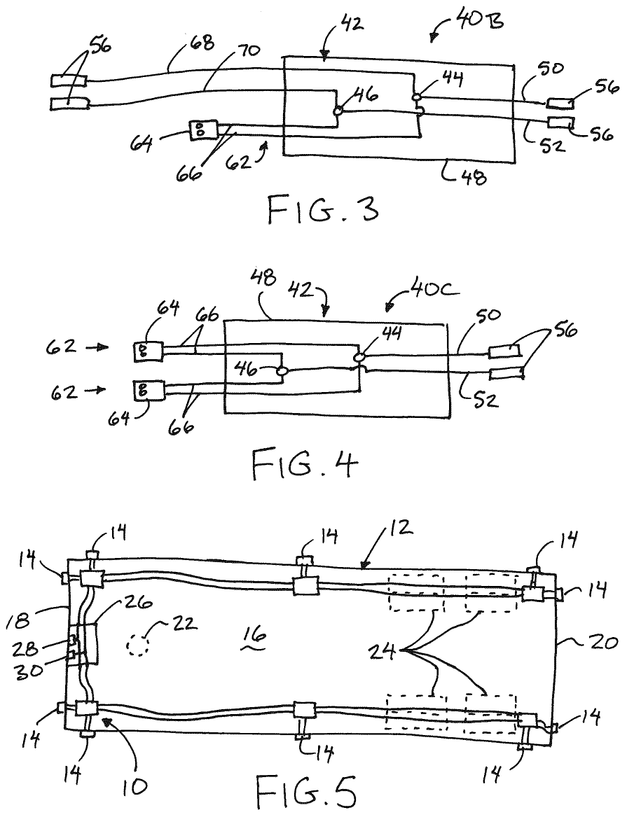

Turning now to the second wiring harness 40B shown in FIG. 3, the harness in this instance includes the splitter 42, the first and second input leads 50 and 52, the first and second output leads 68 and 70, and a single pigtail assembly 62. The second wiring harness 40B is particularly suited for installation at an intermediate location along one side of the trailer such that the pigtail assembly is connected to a single clearance light while the input and output leads can be connected in series with existing wiring extending longitudinally along the length of the trailer between front and rear corners of the trailer.

The third wiring harness 40C shown in FIG. 4 includes the splitter 42, the first and second input leads 50 and 52, and two pigtail assemblies 62. The third wiring harness 40C is well-suited for installation at a corner of the trailer farthest from the junction box such that the pigtail assemblies can be connected to the clearance lights 14 on sides of the trailer that are perpendicular to one another at the corner of the trailer, for example a clearance light at the side of the trailer and a clearance light at the end of the trailer adjacent to the corner.

The wiring harnesses described above are well suited for replacing existing wiring extending between the junction box 26 and existing clearance light locations on the trailer when some of the existing wiring becomes corroded or otherwise damaged. In this instance, the pigtail wiring of the existing lights are removed and the plugs 64 of the pigtail assemblies 62 of the corresponding harnesses are connected to the existing or replacement clearance lights by plugging the plugs 64 into the socket connectors 36 of the lights. Existing leads communicating from the junction box can be cut to the appropriate length for connection to the input leads and the end portions of the existing leads are stripped for suitable connection to the wire connectors 56 of the corresponding input leads 50 and 52. If mounting at the location of a first harness 40A or a second harness 40B, existing wires communicating to other downstream clearance lights are similarly cut to the appropriate length and stripped at the ends thereof for connection to the wire connectors 56 of the output leads of the harness respectively. When replacing wiring to clearance lights at the end of a series connection of clearance lights, the third wiring harness 40C is installed such that no output lead connections are required.

In another instance, all wiring for clearance lights of a trailer may be replaced by selecting the appropriate first, second or third wiring harnesses at the location of each clearance light 14 or pair of lights 14 at a corner. The output leads of the first wiring harness can be connected directly to the corresponding ones of the input leads of the second wiring harness in this instance. Likewise the output leads of the second wiring harness can be connected directly to the corresponding ones of the input leads of the third wiring harness.

In all uses of the wiring harnesses described above, installation of the wiring harness involves (i) lead connections of two leads connected end to end using a simple wire connector 56 that provides a secure weatherproof connection, or (ii) connections of the pigtail plugs 64 to the appropriate socket connectors 36 of the clearance lights. In each instance the connections are performed quickly and easily with minimal tools, and in a manner which results in a secure weatherproof connection.

Since various modifications can be made in the invention as herein above described, and many apparently widely different embodiments of same made, it is intended that all matter contained in the accompanying specification shall be interpreted as illustrative only and not in a limiting sense.

1. A wiring harness for a trailer including clearance lights with socket connectors formed thereon and a junction box having a power terminal and a ground terminal therein, the wiring harness comprising:
a splitter having a first terminal and a second terminal mounted internally within a sealed envelope fully enclosing the first terminal and the second terminal within the sealed envelope;
a first input lead and a second input lead in conductive communication with the first and second terminals of the splitter respectively in which the first input lead and the second input lead extend from the splitter externally of the sealed envelope so as to be arranged for respective conductive communication with the power terminal and the ground terminal of the junction box;
at least one pigtail assembly including (i) a plug arranged for mating connection with the socket connector of a respective one of the clearance lights and (ii) a pair of pigtail leads in conductive communication between the plug and the first and second terminals of the splitter respectively in which the pigtail leads extend from the splitter for connection with the plug externally of the sealed envelope; and
a first output lead and a second output lead in conductive communication with the first and second terminals of the splitter respectively in which the first output lead and the second output lead extend from the splitter externally of the sealed envelope so as to be arranged for respective conductive communication with a first input lead and a second input lead of another wiring harness.

2. The wiring harness according to claim 1 wherein said at least one pigtail assembly comprises two pigtail assemblies, each including (i) a plug arranged for mating connection with the socket connector of a respective one of the clearance lights and (ii) a pair of pigtail leads in conductive communication between the plug and the first and second terminals of the splitter respectively.

3. The wiring harness according to claim 1 wherein the first input lead and the second input lead each include a wire connector mounted on a distal end of the input lead, the wire connector being arranged for connecting the input lead to a corresponding wire coupled to one of the terminals of the junction box such that the corresponding wire and the input lead are joined end to end with one another.

4. The wiring harness according to claim 1 wherein the input leads having a length corresponding to a distance between a corner of the trailer and the junction box of the trailer.

5. The wiring harness according to claim 1 wherein the input leads having a length which is greater than a length of the trailer.

6. The wiring harness according to claim 1 wherein the leads are connected to one another at each terminal of the splitter by crimping.

7. The wiring harness according to claim 1 wherein the leads are connected to one another at each terminal of the splitter by soldering.

8. The wiring harness according to claim 1 wherein the leads are connected to one another at each terminal of the splitter by crimping and soldering.

9. The wiring harness according to claim 1 wherein the sealed envelope of the splitter is formed of plastic material which undergoes shrinkage upon application of heat.

10. A wiring harness for a trailer including clearance lights with socket connectors formed thereon and a junction box having a power terminal and a ground terminal therein, the wiring harness comprising:
a splitter having a first terminal and a second terminal mounted internally within a sealed envelope;
a first input lead and a second input lead in conductive communication with the first and second terminals of the splitter respectively in which the first input lead and the second input lead extend from the splitter externally of the sealed envelope so as to be arranged for respective conductive communication with the power terminal and the ground terminal of the junction box; and
two pigtail assemblies, each including (i) a plug arranged for mating connection with the socket connector of a respective one of the clearance lights and (ii) a pair of pigtail leads in conductive communication between the plug and the first and second terminals of the splitter respectively in which the pigtail leads extend from the splitter for connection with the plug externally of the sealed envelope.

11. A method of connecting a clearance light with a junction box on a trailer in which the clearance light includes a socket connector formed thereon and the junction box includes a power terminal and a ground terminal therein, the method comprising:
providing a wiring harness comprising (i) a splitter having a first terminal and a second terminal mounted internally within a sealed envelope fully enclosing the first terminal and the second terminal within the sealed envelope, (ii) a first input lead and a second input lead in conductive communication with the first and second terminals of the splitter respectively in which the first input lead and the second input lead extend from the splitter externally of the sealed envelope; and (iii) a pigtail assembly including a plug and a pair of pigtail leads in conductive communication between the plug and the first and second terminals of the splitter respectively;
connecting the first input lead and the second input lead of the wiring harness to the power terminal and the ground terminal of the junction box; and
connecting the plug of the pigtail assembly to the socket connector of the clearance light.
